(19) United States
(12) Patent Application Publication
(10) Pub. No.: US 2004/0234826 A1
(43) Pub. Date: Nov. 25, 2004

(54) Method for localising a gas leak in a fuel cell system

(76) Inventor: Walter Stuhler, Hirschaid (DE)

Correspondence Address: HARNESS, DICKEY & PIERCE, P.L.C., P.O.BOX 8910, RESTON, VA, 20195, US

(21) Appl. No.: 10/485,402

(22) PCT Filed: Jul. 25, 2002
(86) PCT No.: PCT/EP02/08307

(30) Foreign Application Priority Data
Aug. 1, 2001 (EP) 01118555.0

(51) Int. Cl. H01M 8/04

(52) U.S. Cl. 429/13; 429/23; 429/25

(57) ABSTRACT

Undetected gas leaks in a fuel cell can lead to a fire inside the fuel cell and thus to the destruction of the fuel cell. A method is for localizing a gas leak inside a fuel cell system including a number of fuel cells. After supplying the fuel cells with the fuel gases, the fuel gas supply to at least one of the two gas chambers of the fuel cells is interrupted. The gas chamber which is separated from the fuel gas supply is rinsed with an inert gas. The fuel cells are brought into electrical contact with a discharging resistor or are already in contact therewith, and the cell voltage of the fuel cells is monitored.

This application is the national phase under 35U.S.C. § 371 of PCT International Application No. PCT/EP02/08307 which has an International filing date of Jul. 25, 2002, which designated the United States of America and which claims priority on European Patent Application number EP 01118555.0 filed Aug. 1, 2001, the entire contents of which are hereby incorporated herein by reference.

### FIELD OF THE INVENTION

The invention generally relates to a method for localizing a gas leak in a fuel cell system having a number of fuel cells.

### BACKGROUND OF THE INVENTION

In a fuel cell, electric current is generated with a high level of efficiency by the electrochemical combination of hydrogen (H₂) and oxygen (O₂) at an electrolyte to form water (H₂O), without any emission of pollutants and carbon dioxide (CO₂) if pure hydrogen is used as the fuel gas. The technical implementation of this fuel cell principle has led to various solutions, specifically using different electrolytes and operating temperatures of between 60° C. and 1000° C. Depending on their operating temperature, the fuel cells are classified as low-temperature, medium-temperature and high-temperature fuel cells, and these are in turn distinguished from one another by virtue of having different technical embodiments.

An individual fuel cell supplies an operating voltage of at most about 1.1 V. Therefore, a large number of fuel cells are connected up to form a fuel cell system, for example, in the case of tubular fuel cells, to form a bundle of tubes; or, in the case of planar fuel cells, to form a stack which is part of a fuel cell block. Connecting the fuel cells of the system in series allows the operating voltage of the fuel cell system to amount to 100 V and above.

A fuel cell has an electrolyte which—depending on its technical design—is pervious either to hydrogen ions or to oxygen ions. An anode adjoins one side of the electrolyte, and this anode is in turn adjoined by an anode gas space. The other side of the electrolyte is adjoined by the cathode of the fuel cell, which in turn has the cathode gas space of the fuel cell adjacent to it. Connection of a plurality of fuel cells in series is made possible by an interconnector plate which electrically connects the anode of a first fuel cell to the cathode of a fuel cell which adjoins this first fuel cell, or some other form of electrical connection produced by an interconnector.

During operation, a hydrogen-containing gas—referred to below as the fuel gas—and an oxygen—containing gas—referred to below as the oxidation gas—are fed to a fuel cell. These two gases are referred to below as operating gases. The fuel gas used is, for example, methane, natural gas, coal gas or pure hydrogen (H₂). The oxidation gas used is generally air, but may also be pure oxygen (O₂).

For operation of the fuel cell, the fuel gas is passed into the anode gas space of the fuel cell, from where it passes through the gas-pervious anode to the electrode. The oxidation gas is passed into the cathode gas space of the fuel cell and from there also passes through the likewise gas-pervious cathode to the electrolyte. Depending on the permeability of the electrolyte to oxygen ions or hydrogen ions, the oxygen ions from the oxidation gas and the hydrogen ions from the fuel gas are combined on one side of the electrolyte or the other, with the result that current and heat are generated as a result of the electrochemical combining of hydrogen and oxygen to form water.

In the event of a leak inside the fuel cell, for example in the electrolyte electrode assembly including the cathode, the electrolyte and the anode, fuel gas escapes from the anode gas space into the cathode gas space or vice versa while the fuel cell is operating. There, the hydrogen and oxygen react to form water, generating only heat but no current. The heat which is formed at the location of the gas leak can destroy the electrolyte electrode assembly around the location of the leak.

If a fuel gas with a high hydrogen content is used, and in particular if pure hydrogen is used, in conjunction with the use of an oxidation gas with a high oxygen content, especially the use of pure oxygen, the amount of heat evolved around the gas leak is so great that the electrolyte electrode assembly is destroyed to such an extent that the gas leak widens and even more gas flows through the leak in an uncontrolled manner. This self-propagating reaction causes the fuel cell to burn within a very short time, and the fire may also completely destroy the adjacent fuel cells or even the entire system. In the most serious instances, there is even a risk of explosion, with far-reaching consequences for the area surrounding the fuel cell system.

To detect a gas leak inside a fuel cell system, there is a known leak test method in which an inert gas is supplied to one of the two gas spaces of the fuel cells of the fuel cell system. Then, these gas spaces are closed off from the environment and the inert gas pressure inside these gas spaces is observed. A drop in the gas pressure over the course of time indicates a leak inside these gas spaces of the fuel cells.

However, this method can only be used to find a major leak inside a fuel cell, but it is also possible for smaller gas leaks to spread quickly when the fuel cell is operating. Moreover, this method only gives an indication that there is a gas leak inside the fuel cell system, but not as to which of the fuel cells within the fuel cell system is damaged.

### SUMMARY OF THE INVENTION

An object of an embodiment of the present invention is to provide a method which allows even a minor leak in the electrolyte electrode assembly of a fuel cell in a fuel cell system to be detected.

An object may be achieved by a method for localizing a gas leak in a fuel cell system having a number of fuel cells, in which, according to an embodiment of the invention

a) fuel gas is supplied to the anode gas space of the fuel cells and oxidation gas is supplied to the cathode gas space of the fuel cells,

b) the supply of operating gas to at least one of the two gas spaces of the fuel cells is interrupted,

c) the gas space of the fuel cells from which the operating gas supply has been disconnected is purged with an inert gas,

d) the fuel cells are in electrical contact with a discharge resistor,

e) the cell voltage of the fuel cells is monitored.

This method is suitable not only for localizing a gas leak which is already known to exist inside a fuel cell system, but also for initial detection of the gas leak.

The individual steps of the method do not necessarily have to be carried out in the order which is predetermined by the letters given above. When interrupting the supply of operating gas to at least one of the two gas spaces of the fuel cells, it is possible to interrupt either the supply of fuel gas to the anode gas spaces of the fuel cells or the supply of oxidation gas to the cathode gas spaces of the fuel cells, or alternatively the supply of both operating gases to the fuel cells. The discharge resistor may already have been connected to the fuel cells before the method according to an embodiment of the invention is started and may remain in electrical contact with the fuel cells while the method is being carried out. However, it is easier to detect a leak if the contact between the fuel cells and the discharge resistor is only made after the purging of the fuel cells with the inert gas has commenced.

The discharge resistor used may be any resistor which discharges the fuel cells in a quantitatively recordable way and at a suitable speed. Therefore, it is possible to use a special discharge resistor designed only for the discharge or an operating load which is supplied with current while the fuel cell system is operating.

When the gas space of the fuel cells which has been disconnected from the supply of operating gas is being purged with an inert gas, a large proportion of the operating gas which is still present in these gas spaces is first of all flushed out of the gas space. However, a certain quantity of operating gas still remains in the gas-pervious electrode and under certain circumstances also in the dead spaces of the gas space and also, for example, in a water separator connected to the gas space. This residual operating gas in the purged gas space is consumed over a certain period of time in a current-generating electrochemical reaction when the fuel cell is brought into contact with the discharge resistor. The length of this period of time is dependent on the quantity of residual operating gas which remains in the purged gas space and the electrical resistance of the discharge resistor.

If there is a leak inside the electrolyte electrode assembly of a fuel cell, depending on the pressure conditions inside the fuel cell either inert gas flows into the unpurged gas space of the defective fuel cell or operating gas flows out of the unpurged gas space of the defective fuel cell into the gas space of the fuel cell which has been purged with the inert gas. If the inert gas flows into the unpurged gas space of the defective fuel cell, it then displaces the operating gas out of the electrode adjoining this gas space.

As a result, the current-generating electrochemical reaction inside the fuel cell drops when the fuel cell is brought into contact with the discharge resistor, so that the defective fuel cell itself can generate less current. If the operating gas passes from the unpurged gas space of the fuel cell into the fuel gas space of the fuel cell which has been purged with inert gas, this operating gas enters into a chemical reaction, which only generates heat, with the residual operating gas from the purged gas space.

As a result, some of the residual operating gas from the gas space of the defective fuel cell which has been purged with inert gas is no longer available for the electrochemical reaction of the fuel cell. The result is that, in this case, too the electrochemical reaction can only take place to a reduced extent. Thus, the defective fuel cell can only produce less current on contact with the discharge resistor than the adjoining, intact fuel cells of the fuel cell system.

While the operating gases are being consumed in the series-connected fuel cells of the fuel cell system, each of the fuel cells of the system makes a contribution, by way of the current which it produces, to the total current of the fuel cell system. This total current of the fuel cell system passes through each fuel cell of the system equally.

If one of the fuel cells is now generating less current, for example on account of a defect in this fuel cell, than the other fuel cells in the system, the fact that the fuel cells are connected in series means that this fuel cell has a lower output voltage than the other fuel cells in the system. While the residual operating gas in the gas space of the fuel cells which has been purged with inert gas is being consumed, the voltage of all the fuel cells of the fuel cell system drops over the course of time, specifically by the extent to which the residual operating gas is consumed in the system.

In the process, the output voltage of a defective fuel cell will drop more quickly than the output voltages of the intact fuel cells of the system. On account of the fact that the same current is flowing through the defective fuel cell as through the intact fuel cells, the output voltage of the defective fuel cell is after a certain time forced down to 0 V and then even below: the polarity of the output voltage of the defective fuel cell is reversed.

Therefore, a defective fuel cell can be detected over a certain period of time while the fuel cells of the fuel cell system are being discharged, on account of its negative output voltage. Therefore, by monitoring the cell voltage of the fuel cells it is possible to unambiguously establish which of the fuel cells of the fuel cell system has a leak, for example in the electrolyte electrode assembly. To a certain extent, it is even possible to establish the magnitude of the leak from the level of the negative output voltage of the defective fuel cell.

The monitoring of the cell voltage should be carried out according to the desired accuracy of localization of the gas leak. If each individual fuel cell of the fuel cell system is monitored, it is possible to accurately localize the defective fuel cell. However, tests have shown that a leak inside a fuel cell which is likely to cause damage leads to such a strong reversal of the polarity of the output voltage of the fuel cell that the leak can be detected and restricted even with less accurate monitoring.

The fuel cells are expediently switched to no-load mode before the supply of operating gas to one of the two gas spaces of the fuel cells is interrupted. The discharge resistor is then connected to the fuel cells while the method is being carried out, most expediently while the gas space of the fuel cells which has been disconnected from the supply of operating gas is being purged with inert gas. The term no-load mode is to be understood as meaning the state of the fuel cells in which they are decoupled from a discharge resistor or an operating load.

During no-load mode, therefore, substantially no current is flowing through the fuel cell system. If the fuel cells are in no-load mode when the purging with an inert gas begins, the inert gas or one of the operating gases can pass through the leak in the fuel cell and spread out in the other gas space before the cell voltage of the defective fuel cell drops as a result of the discharging through the discharge resistor. Therefore, the escaping gas is provided with more time to spread out. As a result, the cell voltage of the defective fuel cell drops more quickly during the discharging of the fuel cell system, and the leak can be recognized and localized more easily.

The method is advantageously carried out after regular operation of the fuel cell system. The first step of the method, namely the supply of fuel gas to the anode gas space and of oxidation gas to the cathode gas space then takes place during regular operation of the fuel cell system. Consequently, the method can be started very easily, without the state of the fuel cell system having to be changed, from running regular operation. It is also possible for the method to be carried out during regular operation, in which case the regular operation of the fuel cell system is interrupted while the voltage of the system is dropping during the method.

The method is carried out with particularly little outlay as a method for switching off the fuel cell system. In this configuration of an embodiment of the invention, carrying out the method requires scarcely any additional time compared to the regular switching off of the system, since to switch off the system it is already necessary to interrupt the supply of operating gas to the fuel cells and generally to purge the fuel cells with an inert gas and discharge them through a discharge resistor.

The method is expediently concluded by all the gas spaces of the fuel cells being flooded with an inert gas. As a result, the fuel cells are brought into a safe at-rest state.

In an advantageous configuration of an embodiment of the invention, the inert gas used is nitrogen (N₂). Nitrogen is particularly inexpensive and does not cause any damage to the materials within a fuel cell.

In a further advantageous configuration of the method, the gas pressure inside the two gas spaces of the fuel cells is brought to a predetermined level before the step of purging with the inert gas. Fuel cells are operated at a relatively high operating gas pressure, for example between 2 and 3 bar (absolute pressure). Such a high operating gas pressure is not required to carry out the method according to an embodiment of the invention. Therefore, the pressure in the gas spaces of the fuel cells can be relieved, for example, prior to the step of purging with the inert gas.

Moreover, setting the operating gas pressures in the gas spaces to a predetermined level means that the method can be carried out at known pressures, for which experience is available, irrespective of any fluctuations in the operating gas pressure. This makes it easier to estimate the magnitude of any leak which may be present.

A further advantage of an embodiment of the invention is achieved if the inert gas pressure is greater than the pressure of the operating gas in the unpurged gas spaces of the fuel cells. In this case, in the event of a leak, the inert gas passes in each case into the other gas space of the fuel cell, where it partially displaces the prevailing operating gas from the pores of the electrode of that gas space. This results in a particularly reproducible method without any uncontrolled chemical reactions. It also ensures that no oxygen passes into the anode-side gas spaces of the fuel cells when these gas spaces are being purged with inert gas. This effectively prevents oxidation of these gas spaces.

In an alternative configuration of the method, the inert gas pressure is selected to be lower than the pressure of the operating gas in the unpurged gas spaces of the fuel cell. The consumption of the residual operating gas in the purged side of the fuel cell by the other operating gas passing over means that in this configuration of an embodiment of the invention it is possible to achieve a more rapid drop in the cell voltage of the defective cell and therefore a particularly pronounced negative cell voltage as the method continues. This makes it easier to detect and localize a particularly minor leak.

The cathode gas spaces of the fuel cells are advantageously purged with the inert gas. The result of this is that when the method is carried out substantially all the oxygen in the fuel cells is consumed. This is particularly expedient if the fuel cell system is shut down for a while after the method has been carried out. In the shut-down state, as little residual oxygen as possible should remain in the fuel cells, so that no damage is caused to the fuel cells by oxidation.

The gas space which has been disconnected from the supply of operating gas is expediently purged with the inert gas for a predetermined first period of time and the discharge resistor is only connected up once the period of time has elapsed. After the period of time has elapsed, the fuel cells can continue to be purged. The inert or operating gas which passes through a leak in the fuel cell needs a while to consume the other operating gas or displace the inert gas in the gas space which it has entered. The selection of a defined period of time allows the method to be carried out reproducibly, which is advantageous when the method is repeated, for example in the event of uncertainty, since the two methods carried out are comparable. Moreover, by using a predetermined period of time it is possible to gain experience of evaluation of the results of the method. Moreover, if the discharge connector is only connected up after the period of time has elapsed, it is ensured that the consumption or displacement of the gases in a damaged fuel cell can manifest itself sufficiently for a leak in the fuel cell which is likely to cause damage and disruption can be reliably detected.

The period of time is expediently selected to be between 10 seconds and 5 minutes. If the method is carried out while the fuel cell installation is operating and if only major leaks are to be detected and localized, a short period of time will suffice. A longer period of time has to be selected if minor leaks are to be detected. In a series of tests, it has proven particularly advantageous for the period of time to be selected to be between 60 and 120 seconds. Within this time, the gas which passes between gas spaces can spread out sufficiently in the other gas space yet sufficient residual operating gas nevertheless remains in the purged gas spaces of the fuel cells.

In an alternative method, the discharge resistor is only connected up when the voltage of the fuel cell system has dropped to a predetermined value. When the gas space of the fuel cells which has been disconnected from the supply of operating gas is being purged, the inert gas displaces some of the operating gas out of the gas-pervious electrode of this gas space. This leads to a slow drop in the cell voltage of the fuel cells even when the discharge resistor is not connected up. This drop in the cell voltage can also be used as a reproducible measure of the extent of any gas escaping through a leak. This makes it possible to compare methods carried out at different times.

The no-load voltage of a fuel cell is approximately 1.15 V. It has been established in numerous tests that an advantageous predetermined cell voltage value for the discharge resistor to be connected up when the voltage drops below this value or shortly afterwards is between 0.8 and 1.05 V. When the cell voltage has dropped to this value, it is possible to particularly sensitively determine a leak in an electrolyte electrode assembly of a fuel cell.

In a further advantageous configuration of an embodiment of the invention, the resistance of the discharge resistor is such that the fuel cells of the fuel cell system are discharged from 1 V to 100 mV within at most 20 seconds of the discharge resistor being connected up. If the discharge resistor is connected up at a cell voltage of 1000 mV. Therefore, the cell voltage of the intact fuel cells drops from 1000 mV to 100 mV in at most 20 seconds.

The resistance of the discharge resistor in this case depends on the current which is generated by the fuel cell system and therefore on the number and size of the fuel cells in the fuel cell system. The time of 20 seconds is such that it is readily possible to detect a reversal in the polarity of a defective fuel cell even without the cell monitoring being read out by a machine device. If the time which it takes for the cell voltage to drop below 100 mV is significantly longer than 20 seconds, the effect of the polarity reversal becomes undefined, since the difference in the cell voltages between a defective fuel cell and an intact fuel cell is then only slight.

It is expedient for the fuel cells to be discharged from a cell voltage of 1 V to 50 mV within 3 to 10 seconds of the discharge resistor being connected up. In tests, a discharge rate of this nature has proven particularly favorable for detection of a minor gas leak.

A defective cell is localized with particular accuracy if the cell voltage of each cell is monitored individually.

Alternatively, the cell voltage of the fuel cells is monitored in groups of at most five fuel cells. This reduces the measurement outlay compared to individual cell monitoring considerably. The polarity reversal of a damaged fuel cell is so significant that a reversal in the polarity of a fuel cell and therefore leakage damage in the monitored group can still be detected even if in each case at most five cell voltages are combined to form a single measured value. An advantageous compromise between reliable and accurate localization and measurement outlay is achieved if the cell voltage of groups of in each case two or three fuel cells is monitored.

With machine-based recording of the cell voltage at predetermined time intervals, with the voltage being output to a display unit, for example a screen, it is possible for the cell voltage of the fuel cells of the fuel cell system to be visually monitored particularly easily.

Particularly accurate monitoring of the cell voltage of the fuel cells which can also be retrospectively documented is achieved by the cell voltage being recorded by a machine device at predetermined time intervals and stored on a data carrier. Even only very brief and weak polarity reversals can be detected in this way. Moreover, this means that the data is available for subsequent analysis, for example for long-term monitoring of a fuel cell system.

The method is expediently applied to fuel cells which are designed to operate with pure oxygen (O₂) and pure hydrogen (H₂). In the case of fuel cells which are operated with pure oxygen and pure hydrogen, the risk of one or more fuel cells burning up as a result of a leak within the fuel cell is particularly high. Therefore, the monitoring of fuel cells of this type for minor leaks is particularly advantageous.

The method is particularly advantageously used for PEM fuel cells (Proton Exchange Membrane fuel cells). These cells are particularly sensitive to fire, and consequently the advantages of an embodiment of the invention are particularly pronounced for cells of this nature.

### BRIEF DESCRIPTION OF THE DRAWINGS

Further advantages, features and details of the invention will become evident from the description of illustrated embodiments given hereinbelow and the accompanying drawing, which is given by way of illustration only and thus is not limitative of the present invention, wherein:

FIG. 1 shows a fuel cell system for carrying out the method;

FIG. 2 shows a flow diagram of the method;

FIG. 3 shows a cell voltage curve of an intact fuel cell while the method is being carried out;

FIG. 4 shows a cell voltage curve of a defective fuel cell while the method is being carried out;

FIG. 5 shows cell voltages of fuel cells of a fuel cell system at a time instant while the method is being carried out.

### DETAILED DESCRIPTION OF THE PREFERRED EMBODIMENTS

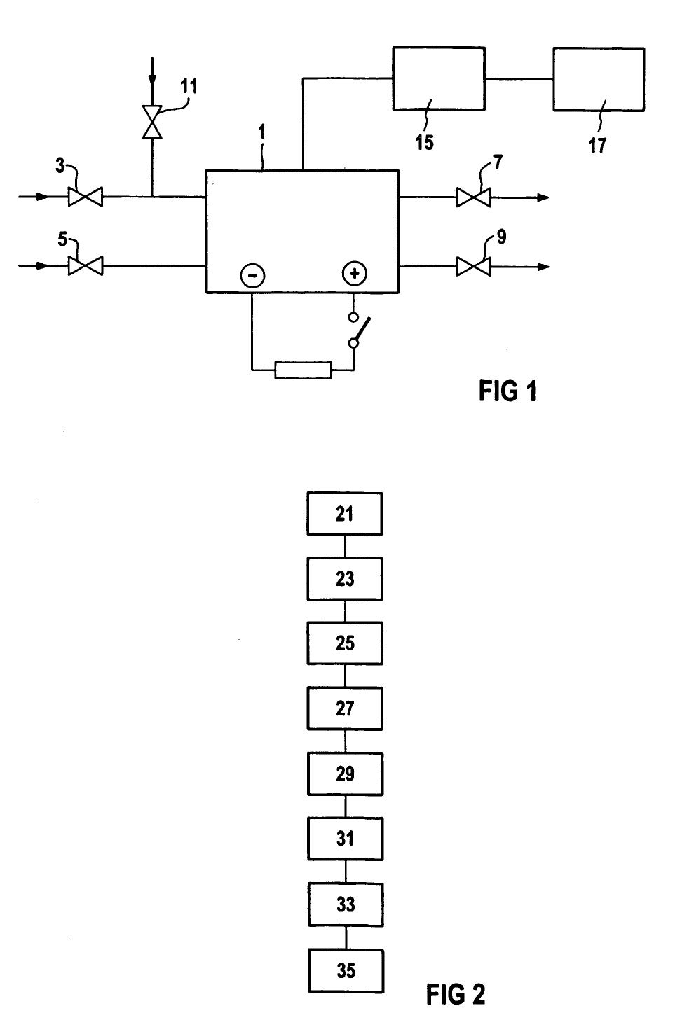

FIG. 1 diagrammatically depicts a fuel cell installation which includes a fuel cell system 1 having a number of fuel cells. The fuel cells are planar fuel cells which are stacked to form a fuel cell stack. Moreover, the fuel cell installation comprises an oxidation gas inlet valve 3, a fuel gas inlet valve 5, an oxidation gas outlet valve 7, a fuel gas outlet valve 9 and an inert gas inlet valve 11. Furthermore, the fuel cell installation includes a discharge resistor 13 and a fuel cell monitoring device 15 and an evaluation unit 17 in the form of a computer with connected screen. The fuel cell system includes 260 PEM fuel cells which are designed for operation with pure oxygen (O₂) as oxidation gas and pure hydrogen (H₂) as fuel gas.

FIG. 2 shows a flow diagram of a method for localizing a gas leak in a fuel cell system, in which, in a first method step 21, during regular operation of the fuel cell system 1 the anode gas space of the fuel cells of the fuel cell system 1 is supplied with pure hydrogen and the cathode gas space of the fuel cells is supplied with pure oxygen. In a subsequent method step 23, the fuel cell system 1 is electrically disconnected from an operating load—a drive of a vehicle—which is not shown in the figures and is switched to a no-load mode. Then, the supply of operating gas to the gas spaces of the fuel cells of the fuel cell system 1 is interrupted 25 by the oxidation gas inlet valve 3 and the fuel gas inlet valve 5 of the fuel cell installation being closed. The inert gas inlet valve 11 of the fuel gas installation is likewise closed at this instant.

In the next method step 27, the gas pressure inside the anode gas space of the fuel cells is expanded from 2.3 bar hydrogen to 1.6 bar (in each case absolute pressure). The gas pressure of the oxygen inside the cathode gas space is likewise expanded, from an operating pressure of 2.6 bar to 1.6 bar. Then, the fuel gas outlet valve 9 is closed, so that the anode gas spaces of the fuel cells of the fuel cell system 1 are hermetically sealed.

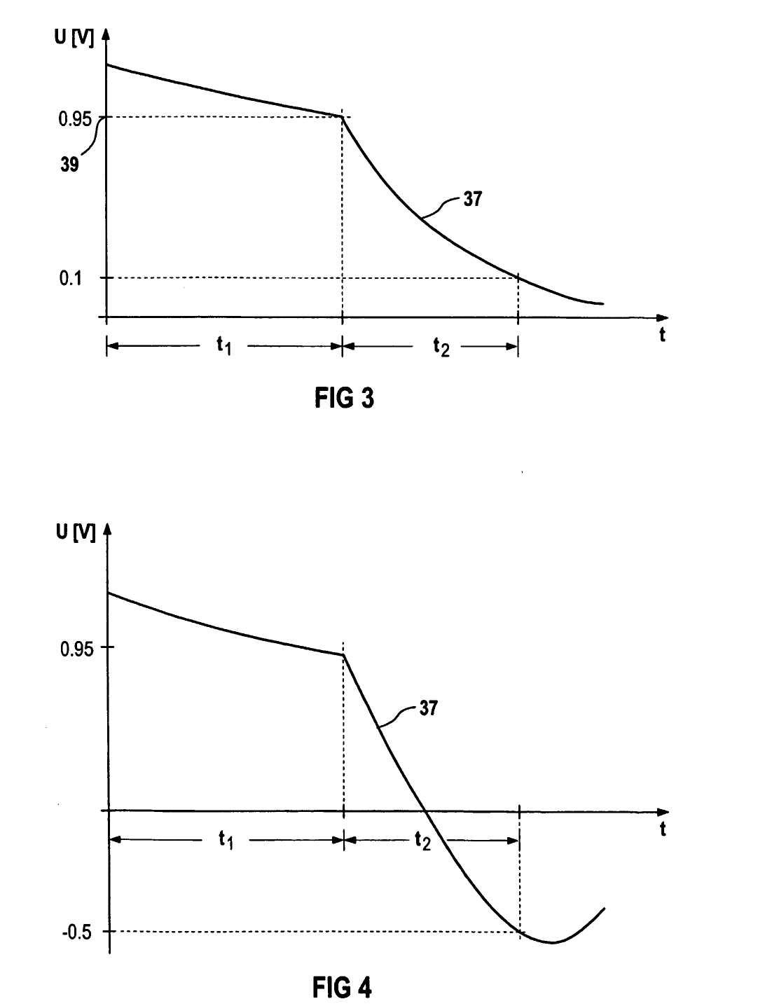

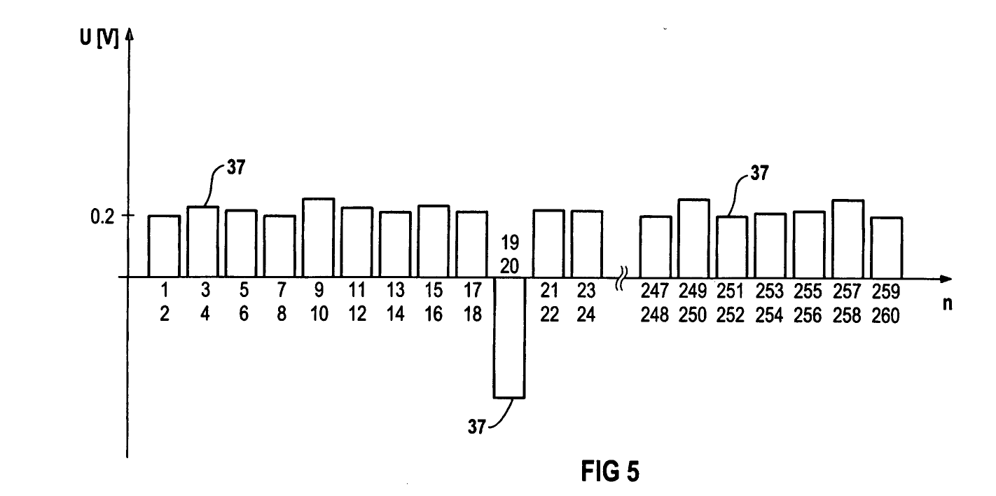

In the next step 29 of the method, the inert gas inlet valve 11 is opened and the cathode gas space of the fuel cells is purged with nitrogen (N₂). In this case, the nitrogen is admitted to the cathode gas spaces of the fuel cells at a pressure of 2 bar. After a first time period t₁ shown in FIGS. 3 and 4, the discharge resistor 13 is brought (31) into electrical contact with the fuel cells of the fuel cell system 1. The resistance of the discharge resistor 13 is 10 Ω. Then, the cell voltages 37 of the fuel cells are monitored (33).

After the discharge resistor 13 has been connected up, the cell voltage 37 of the intact fuel cells of the fuel cell system 1 drops from 950 mV to approximately 100 mV within a second time period t₂ illustrated in FIG. 3. The time period t₂ is approximately 7 s. During the same second time period t₂, the cell voltage 37 of a defective fuel cell, which has a leak in the electrolyte electrode assembly, as illustrated in FIG. 4, drops significantly more quickly than the cell voltage 37 of the intact cells of the fuel cell system 1.

On account of the current which is driven through the defective fuel cell, the polarity of the cell voltage 37 of the defective fuel cell is reversed and reaches a value of approximately −500 mV after the second time period t₂ has elapsed. While the cathode gas spaces are being purged with nitrogen and the fuel cells discharged, the cell voltage 37 of the fuel cells of the fuel cell system 1 is permanently monitored by the fuel cell monitoring device 15.

The values for the fuel cell voltages 37 are transmitted from the fuel cell monitoring device 15 to the evaluation unit 17, which stores these values at periodic intervals and also outputs them on a screen. In a final method step 35, the gas spaces of the fuel cells of the fuel cell system 1 are flooded with nitrogen and the oxidation gas outlet valve 7 which has previously been open is closed. Once the inert gas inlet valve 11 has subsequently been closed, therefore, the cathode gas spaces of the fuel cells of the fuel cell system 1 are also hermetically sealed off from the outside world.

During the first time period t₁, the cell voltage 37 of the intact fuel cells of the fuel cell system 1 drops from the no-load voltage of approximately 1.15 V to a second voltage of approximately 0.95. In an alternative form of the method, this second voltage can be used as a trigger voltage 39 for connecting the discharge resistor 13 to the fuel cells of the fuel cell system 1. In this case, the second voltage value is determined by measuring the total voltage of the fuel cell system 1 and dividing this value by the number of fuel cells.

FIG. 5 shows the data of the cell voltages which have been stored by the evaluation unit at a time instant just before the end of the second time period t₂. A voltage value is in this case composed of the cell voltage 37 of two adjacent fuel cells, in each case illustrated in one block. The cell voltage 37 of two adjacent cells is therefore approximately 200 mV for almost all the cells. Therefore, an individual cell has a cell voltage of approximately 100 mV. Only the combined cell voltage 37 of the two fuel cells 19 and 20 of the 260 fuel cells of the fuel cell system 1 have a strongly negative voltage value. It is apparent from this negative voltage value that either one of the two fuel cells 19 or 20 has a leak between its two gas spaces or possibly even both fuel cells 19 and 20 are damaged.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for localizing a gas leak in a fuel cell system having a number of fuel cells, comprising:
supplying fuel gas to an anode gas space of the fuel cells and supplying oxidation gas to a cathode gas space of the fuel cells;
interrupting the supply of operating gas to at least one of the two gas spaces of the fuel cells;
purging the gas space of the fuel cells, from which the operating gas supply has been disconnected, with an inert gas; and
monitoring the cell voltage of the fuel cells, wherein the fuel cells are in electrical contact with a discharge resistor.

2. The method as claimed in claim 1, wherein the fuel cells are switched to no-load mode before the supply of operating gas to the fuel cells is interrupted.

3. The method as claimed in claim 1, wherein the method is carried out after regular operation of the fuel cell system, with fuel gas being supplied to the anode gas space and oxidation gas to the cathode gas space during regular operation.

4. The method as claimed in claim 1, wherein the method is carried out as a method for switching off the fuel cell system.

5. The method as claimed in claim 4, further comprising:
flooding all the gas spaces of the fuel cells with an inert gas to conclude the method.

6. The method as claimed in claim 1, wherein the inert gas used is nitrogen.

7. The method as claimed in claim 1, wherein the gas pressure inside the two gas spaces of the fuel cells is brought to a predetermined level before purging with an inert gas.

8. The method as claimed in claim 1, wherein the inert gas pressure is greater than the pressure of the operating gas in the unpurged gas spaces of the fuel cell.

9. The method as claimed in claim 1, wherein the inert gas pressure is lower than the pressure of the operating gas in the unpurged gas spaces of the fuel cells.

10. The method as claimed in claim 1, wherein the cathode gas spaces of the fuel cells are purged with the inert gas.

11. The method as claimed in claim 1, wherein the gas space which has been disconnected from the supply of operating gas is purged with the inert gas for a predetermined first period of time, and wherein the discharge resistor is only connected up once the first period of time has elapsed.

12. The method as claimed in claim 1, wherein the discharge resistor is only connected up when the voltage of the fuel cell system has dropped to a predetermined value.

13. The method as claimed in claim 1, wherein the resistance of the discharge resistor is such that the fuel cell are discharged from 1 V to 100 mV within a second period of time of at most 20 s of the discharge resistor being connected up.

14. The method as claimed in claim 1, wherein the cell voltage of each cell is monitored individually.

15. The method as claimed in claim 1, wherein the cell voltage of the cells is monitored in groups of at most five cells.

16. The method as claimed in claim 1, wherein the cell voltage of the cells is monitored for a reversal of polarity.

17. The method as claimed in claim 1, wherein the cell voltage is recorded at predetermined time intervals and is output on a display unit.

18. The method as claimed in claim 1, wherein the cell voltage is recorded at predetermined time intervals and is stored on a data carrier.

19. The method as claimed in claim 1, wherein the method is applied to fuel cells which are designed to operate with pure oxygen and with pure hydrogen.

20. The method as claimed in claim 1, wherein the method is applied to PEM fuel cells.

21. The method as claimed in claim 2, wherein the method is carried out after regular operation of the fuel cell system, with fuel gas being supplied to the anode gas space and oxidation gas to the cathode gas space during regular operation.

22. An apparatus for localizing a gas leak in a fuel cell system having a number of fuel cells, comprising:
means for supplying fuel gas to a first gas space of the fuel cells and supplying oxidation gas to a second gas space of the fuel cells;
means for interrupting the supply of operating gas to at least one of the two gas spaces of the fuel cells;
means for purging the gas space of the fuel cells, from which the operating gas supply has been interrupted, with an inert gas; and
means for monitoring the cell voltage of the fuel cells, wherein the fuel cells are in electrical contact with a discharge resistor.

23. A method for localizing a gas leak in a fuel cell system including a plurality of fuel cells, comprising:
supplying fuel gas to a first gas space of the fuel cells and supplying oxidation gas to a second gas space of the fuel cells;
interrupting the supply of operating gas to at least one of the two gas spaces of the fuel cells;
purging the gas space of the fuel cells, from which the operating gas supply has been interrupted, with an inert gas; and
monitoring the cell voltage of the fuel cells, wherein the fuel cells are in electrical contact with a discharge resistor.

24. The method as claimed in claim 23, wherein the fuel cells are switched to no-load mode before the supply of operating gas to the fuel cells is interrupted.

25. The method as claimed in claim 23, wherein the method is carried out after regular operation of the fuel cell system, with fuel gas being supplied to the anode gas space and oxidation gas to the cathode gas space during regular operation.

26. The method as claimed in claim 23, wherein the method is carried out as a method for switching off the fuel cell system.

27. The method as claimed in claim 26, further comprising:
flooding all the gas spaces of the fuel cells with an inert gas to conclude the method.

28. The method as claimed in claim 23, wherein the inert gas used is nitrogen.

29. The method as claimed in claim 23, wherein the gas pressure inside the two gas spaces of the fuel cells is brought to a predetermined level before purging with an inert gas.

30. The method as claimed in claim 23, wherein the inert gas pressure is greater than the pressure of the operating gas in the unpurged gas spaces of the fuel cell.
